(19) United States
(12) Patent Application Publication
(10) Pub. No.: US 2008/0278370 A1
(43) Pub. Date: Nov. 13, 2008

(54) RF-FRONTEND FOR A RADAR SYSTEM

(76) Inventors: Rudolf Lachner, Ingolstadt (DE); Hans-Peter Forstner, Steinhoering (DE)

Correspondence Address: ESCHWEILER & ASSOCIATES LLC, 629 EUCLID AVENUE, SUITE 1000, NATIONAL CITY BUILDING, CLEVELAND, OH, 44114, US

(21) Appl. No.: 11/866,276

(22) Filed: Oct. 2, 2007

Related U.S. Application Data
(63) Continuation-in-part of application No. 11/746,480, filed on May 9, 2007.

(51) Int. Cl. G01S 13/00

(52) U.S. Cl. 342/200

(57) ABSTRACT

An RF front-end includes an input configured to receive an oscillator signal, and an antenna port configured to transmit a transmission signal and receive a reception signal from an antenna. The RF front-end further includes a mixer having an RF-input configured to receive the reception signal, an oscillator input configured to receive a modified oscillator signal, and an output. The mixer is configured to mix the received signal into an intermediate frequency band or a base band using the oscillator signal. Also included is a directional coupler connected to the antenna port, the input for the oscillator signal, and the mixer. The coupler is configured to couple the oscillator signal as a transmission signal to the antenna via the antenna port, and couple the reception signal from the antenna to the RF-input of the mixer. Also included is a first phase shifter or a second phase shifter. The first phase shifter is configured to regulate a phase of the transmission signal, and the second phase shifter is configured to regulate a phase of the oscillator signal to form the modified oscillator signal supplied to the oscillator input of the mixer.

### REFERENCE TO RELATED APPLICATIONS

This application is a Continuation-In-Part of Ser. No. 11/746,480 filed ______, which is entitled “Packaged Antenna and Method for Producing the Same.”

### TECHNICAL FIELD

The invention relates to a radio frequency transmitter/receiver frontend for a radar system.

### BACKGROUND

Known radar systems which are currently used for distance measurement in vehicles sometimes comprise two separate radars which operate in different frequency bands. For distance measurements in a near area (short range radar), radars which operate in a frequency band around a mid-frequency of 24 GHz are commonly used. In this case, the expression “near area” means distances in the range from 0 to about 20 meters from the vehicle (short range radar). The frequency band from 76 GHz to 77 GHz is currently used for distance measurements in the “far area”, that is for measurements in the range from about 20 meters to around 200 meters (long range radar). These different frequency bands is prejudicial to the concept of one single radar system for both measurement areas and often require two separate radar devices.

The frequency band from 77 GHz to 81 GHz is likewise suitable for short range radar applications. A single multirange radar system which carries out distance measurements in the near area and far area using a single radio-frequency transmission module (RF front-end) has, however, not yet been feasible for various reasons. One reason is that circuits which are manufactured using III/V semiconductor technologies (for example gallium-arsenide technologies) are used at the moment to construct known radar systems. Gallium-arsenide technologies are admittedly highly suitable for the integration of radio-frequency components, but it is not possible to achieve a degree of integration which is as high, for example, of that which would be possible with silicon integration, as a result of technological restrictions. Furthermore, only a portion of the required electronics are manufactured using GaAs technology, so that a large number of different components are required to construct the overall system.

However, a high number of components is not desirable, since losses and reflections arise in each component, especially in the signal path downstream to the RF power amplifier. These losses and reflections have an undesired negative impact on the efficiency of the overall system. Furthermore, it is desirable to use many equal devices in a radar system, which may be flexibly utilized in different applications. Thus there is a general need for a RF transmitter/receiver front-end which provides for high flexibility at high integration level and high efficiency.

### SUMMARY

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

A multirange radar system has a first operating mode for measurement in a first range zone (near area) and a second operating mode for measurement in a second range zone (far area). In one embodiment the radar system has a radio-frequency (RF) transmission module with an oscillator for providing a transmission signal with a first frequency spectrum in the first operating mode, and with a second frequency spectrum in the second operating mode. It also has at least one antenna, which is connected to the RF transmission module, and a control and processing unit, which provides control signals which are supplied to the RF transmission module for setting the operating modes. The oscillator which is used can be tuned by means of a control voltage over a frequency range which includes the frequencies of both frequency spectra. An oscillator such as this can be produced by the use of bipolar and BiCMOS technologies.

The transmission/reception characteristics of the transmitting and receiving antennas that are used may be switched by means of a control signal which is produced by the control and processing unit. Two different antennas with different transmission and reception characteristics may be provided for the two operating modes, wherein in one embodiment only one of the two antennas is active, as a function of the operating mode. Control signals are likewise used for switching between the antennas, and are provided by the control and processing unit. A multirange radar according to this embodiment operates using the time-division multiplexing mode.

In one embodiment the two antennas may not be activated with a time offset, but they transmit and receive signals in different frequency ranges at the same time. In this case, one frequency range is in each case associated with one antenna (or a group of antennas) and one measurement range (short range or long range). A multirange radar according to this embodiment operates using the frequency-division multiplexing mode.

The use of the bipolar or BiCMOS production methods allows a multirange radar system to be integrated using a single semiconductor technology. The use of a transmission oscillator which can be tuned over a very wide range and of a suitable control unit which allows switching between antennas for the short range and for the long range or, when using a common antenna for both measurement ranges, switching of the reception characteristics of one antenna, allows the “combination” of a short-range radar and a long-range radar in a single multirange radar system with a considerable reduction of components. The cost reduction associated with this facilitates use of radars in lower and medium price-class vehicles.

In one embodiment phase shifters may be employed in the RF frontend for adjusting the transmit/receive characteristic of the antenna. Such an RF frontend comprises: an input for an oscillator signal; an antenna for transmitting a transmission signal and for receiving a receive signal; a mixer comprising an RF-input, an oscillator-input and an output for mixing the received signal into an intermediate frequency band or a base band; a directional coupler being connected with the antenna, the input for the oscillator signal, and the mixer, and being configured to couple the oscillator signal as transmission signal to the antenna and to couple the signal received from the antenna to the RF-input of the mixer. The front end further comprises a first and/or a second phase shifter, where the first phase shifter is configured to regulate the phase of the transmission signal and the second phase shifter is configured to regulate the phase of the oscillator signal that is supplied to the oscillator input of the mixer.

In one embodiment the antenna characteristic may be modified by means of the first phase shifter. The second phase shifter of the front end is configured to alternately provide a phase shift of 0° and 90°, thus providing alternately the inphase and quadrature component of the baseband (or intermediate frequency band) signal at the output of the mixer.

An RF frontend may comprise a configurable mixer arrangement that may be configured for a receive-only mode or alternatively for a combined receive/transmit-mode of the attached antennas, thus providing a flexibly applicable and standardized RF frontend.

In one embodiment the RF transmitter/receiver frontend comprises a terminal for receiving an oscillator signal, at least one distribution unit for distributing the oscillator signal into different signal paths, two or more mixer-arrangements for sending a transmit-signal or for receiving a receive-signal, where each mixer-arrangement comprises a mixer and an amplifier for amplifying the oscillator signal and generating the transmit-signal.

One embodiment of the mixer-arrangement comprises an oscillator terminal for receiving an oscillator signal, an RF terminal for connecting an, antenna, a base-band terminal for providing a base-band signal, a mixer having a first input which is connected to the oscillator terminal, a second input, and an output which is connected with the base-band terminal, a directional coupler which is connected with the oscillator-terminal and the RF terminal for coupling the oscillator signal to the antenna and for coupling a signal received from the antenna to the second input of the mixer, and a disconnecting device for interrupting the signal.

In one embodiment the amplifier of the transmitter/receiver front-end is enabled and disabled by a control signal. In this embodiment the amplifier also serves as the disconnecting device of the mixer arrangement. The disconnecting device may comprise fusable strip lines or the like. The electrical contacts established by such “fuses” may be cut through (e.g. “fused”) by means of, for example, a laser. Such fuses are known as “laser fuses”.

With the help of the mixer arrangement the RF sender/receiver front-end may be configured to operate either in a pure receive-mode or in a combined send-and-receive-mode of an antenna which is connected to the RF front-end.

A further embodiment of an RF front-end circuit comprises a directional coupler, a mixer, and a reflection circuit. The directional coupler is adapted to receive an antenna signal and an oscillator signal. The mixer is coupled to the directional coupler to receive the antenna signal and is further adapted to receive a mixer signal and generate an output signal related to the antenna signal and the mixer signal. The reflection circuit is coupled to the directional coupler to receive the oscillator signal and is adapted to reflect at least a portion of the oscillator signal to the mixer via the directional coupler to counteract a parasitic portion of the oscillator signal received at the mixer.

### BRIEF DESCRIPTION OF THE DRAWINGS

The invention can be better understood with reference, to the following drawings and description. The components in the figures are not necessarily to scale, instead emphasis being placed upon illustrating the principles of the invention. Moreover, in the figures, like reference numerals designate corresponding parts. In the drawings:

FIG. 1 shows a radar system in which the same antenna is used for long-range and short-range measurements according to one embodiment of the invention;

FIG. 2 shows a radar system with different antennas for long-range and short-range measurements according to another embodiment;

FIG. 3 shows a more detailed illustration of the system shown in FIG. 2 according to one embodiment;

FIG. 4 shows a more detailed illustration of the system illustrated in FIG. 3;

FIG. 5 shows an alternative embodiment to the system illustrated in FIG. 4;

FIG. 6 shows the internal design of the transmission oscillator in the form of a block diagram according to one embodiment;

FIG. 7A shows a mixer-arrangement for mixing a RF receive-signal into the base-band according to one embodiment;

FIG. 7B shows a mixer-arrangement for a combined send-and-receive-mode of operation of a connected antenna according to one embodiment;

FIG. 8A shows a mixer-arrangement which is configured to operate in a combined send-and-receive mode of operation, the mixer-arrangement being configurable by a control signal and comprising an amplifier which can be enabled and disabled by the control signal according to one embodiment;

FIG. 8B shows a mixer-arrangement which is configured to operate in a pure receive mode of operation, the mixer-arrangement being configurable by a control signal and comprising an amplifier which can be enabled and disabled by the control signal according to another embodiment of the invention;

FIG. 9A shows a mixer-arrangement which is configurable by laser fuses according to one embodiment;

FIG. 9B shows a mixer-arrangement which is configurable by laser fuses, the mixer-arrangement being configured to operate in a pure receive mode of operation according to one embodiment;

FIG. 9C shows a mixer-arrangement which is configurable by laser fuses, the mixer-arrangement being configured to operate in a combined send-and-receive mode of operation according to another embodiment;

FIG. 10 shows one embodiment of the switchable amplifier of FIG. 8A or 8B;

FIG. 11 shows one embodiment of the inventive RF transmitter/receiver front-end comprising the configurable mixer of FIG. 8A or 8B;

FIG. 12 illustrates a conventional RF frontend comprising a directional coupler and a mixer;

FIG. 13 illustrates a mixer arrangement comprising a directional coupler, a mixer, and a reflection circuit that is connected to the directional coupler;

FIG. 14 illustrates the mixer arrangement of FIG. 13 with a reflection circuit comprising a delay line and an ohmic resistance according to one embodiment;

FIG. 15 illustrates the mixer arrangement of FIG. 13 with an alternative reflection circuit, that comprises a delay line and a power divider according to one embodiment;

FIG. 16 illustrates a further example of the reflection circuit of FIG. 13 in more detail according to one embodiment;

FIG. 17 illustrates an alternative embodiment mixer arrangement to the mixer arrangement of FIG. 13 providing the same function;

FIG. 18 illustrates a mixer arrangement comprising phase shifters according to one embodiment;

FIG. 19 is a sectional view of a chip with an integrated antenna arrangement according to one embodiment;

FIG. 20 is a top view of the chip of FIG. 19;

FIG. 21 is a sectional view of the an alternative embodiment of the chip of FIG. 19 comprising a circuit;

FIG. 22 is a circuit diagram of a part of a circuit of the embodiment of FIG. 21.

FIG. 23 is a sectional view of a further embodiment of a chip with an integrated antenna arrangement;

FIG. 24 is a sectional view of a further embodiment of a chip with an integrated antenna arrangement;

FIG. 25 is a sectional view of a further embodiment of a chip with an integrated antenna arrangement;

FIG. 26 is a sectional view of a further embodiment of a chip with an integrated antenna arrangement;

FIG. 27 is typical, simplified block diagram of a data transmitter;

FIG. 28 is a typical, simplified block diagram of a data receiver;

FIG. 29 is a sectional view of a further embodiment of a chip with an integrated antenna arrangement;

FIG. 30 is a sectional view of a further embodiment of the invention; and

FIG. 31 is a sectional top view of the embodiment of FIG. 30.

### DETAILED DESCRIPTION

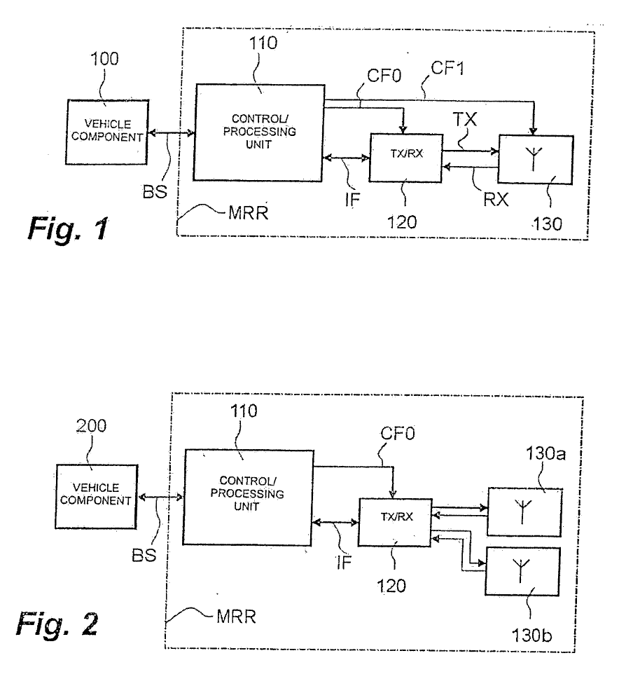

FIG. 1 uses a block diagram to illustrate the basic structure of one embodiment of a radar system. The actual multirange radar MRR has a control and processing unit 110 which is connected to the other vehicle components 100 via a specific interface, for example the vehicle bus (BS). The multirange radar MRR also comprises a radio-frequency (RF) transmission module (TX RX) 120 and an antenna module 130 which comprises one or more individual antennas. In one embodiment the control and processing unit 110 may be designed predominantly using CMOS technology, whereas the RF transmission module 120 may be designed predominantly using bipolar technology. However, it is also possible to integrate both parts jointly using BiCMOS technology. The multirange radar comprises at least two range measurement zones, a near area for ranges between 0 and about 20 meters (short-range radar), and a far area with ranges from around 20 meters to about 200 meters (long-range radar). Since both the transmission and reception characteristics of the active antennas as well as the required bandwidth of the transmitted radar signal are different in these two measurement ranges, both the antenna module 130 and the radio-frequency transmission module 120 can be configured in one embodiment by means of control signals CF0 and CF1, which are provided by the control and processing unit 110, in accordance with the desired measurement range. The details of this configuration capability will be explained in more detail further below.

In one embodiment an antenna with a fairly broad emission angle is desirable for a measurement in the short range and an antenna with a narrow emission angle and a high antenna gain is desirable for measurement in the long range. For this reason, phased-array antennas may be used in one embodiment in the antenna module 130, whose transmission/reception angle can be varied by driving different antenna elements with the same antenna signal, but with a different phase angle of the antenna signal. Variation of the transmission and reception characteristics of antennas by means of an appropriate driver is also referred to as electronic beam-control or digital beam-forming.

The RF transmission module 120 in one embodiment also comprises the radio-frequency front-end which is required for the reception of the reflected radar signals. The received radar signals are mixed to baseband with the aid of a mixer, the baseband signal IF is then supplied from the radio-frequency transmission module 120 to the control and processing unit 110, which digitizes the baseband signal IF and processes it further by digital signal processing. It is not only possible to provide a separate transmitting antenna and receiving antenna (bistatic radar), but also a common antenna for transmission and reception of radar signals (monostatic radar). In the second case, a directional coupler is employed to separate the transmitted signals and the received signals. The internal design of the RF transmission module 120 and of the antenna modules 130 will likewise be described in more detail later.

Electronic beam control (digital beam-forming) allows a minimal number of components, but requires considerably greater control logic complexity. For this reason, different antennas 130a and 130b may be used for the different measurement ranges, as is shown in the embodiment illustrated in FIG. 2. The block diagram in FIG. 2 differs from that in FIG. 1 in that two antenna modules 130a and 130b are provided instead of the antenna module 130 which can be configured via the control signal CF1, and their emission and reception characteristics are not adjustable. For example, the antenna 130a is designed in one embodiment for measurements in the short range, and the antenna 130b is designed for measurements in the long range. However, the transmission signals are generated and the received signals are mixed in a common radio-frequency sender/receiver front-end 120. When using two antennas, it is also possible to concurrently carry out measurements in the short range and in the long range (frequency multiplexing mode) instead of alternate measurement (time multiplexing mode).

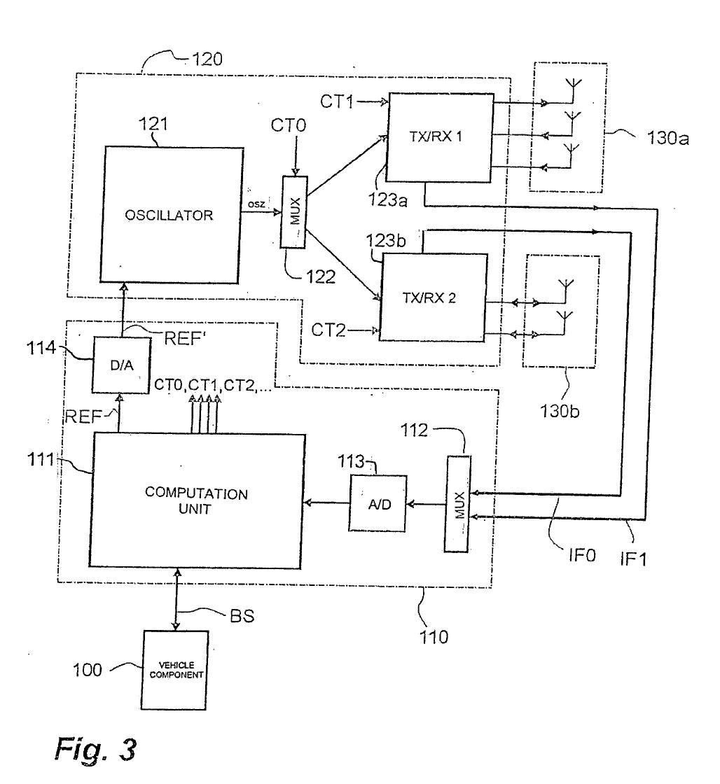

FIG. 3 shows an example of the embodiment illustrated in FIG. 2, but with the control and processing unit 110 and the RF transmitter/receiver front-end 120 being illustrated in more detail. The control and processing unit 110 comprises a computation unit 111, a digital/analog converter (D/A) 114, an analog/digital converter (D/A) 113 with an upstream distribution block (D/A) 112 which, for example, may be in the form of a multiplexer. The RF sender/receiver front-end 120 comprises a radio-frequency oscillator 121, which produces the transmission signal, a distribution unit (MUX) 122 which distributes the signal power, depending on the operating mode, to a first transmitting/receiving circuit (TX/RX1) 123a or to a second transmitting/receiving circuit (TX/RX2) 123b (time multiplexing mode), or else between both transmitting/receiving circuits 123a and 123b (frequency multiplexing mode). The RF-frontend 120 may be arranged in one package together with the antenna 130a, 130b in one embodiment. The RF-oscillator 121 and the distribution unit 122 may, however, be arranged in a separate chip. This is especially useful if the oscillator signal to be transmitted should be distributed to several. RF frontends 120 which are spatially separated from each other.

As already mentioned, the multirange radar comprises a first operating mode for measurement of distances in the short range, and a second operating mode for measurement of distances in the long range. The operating mode is elected by the computation unit 111 by providing the appropriate control signals CT0, CT1 and CT2. The control signals CT1 and CT2 respectively activate and deactivate the respective transmitting/receiving circuits 123A and 123B, and the control signal CT0 configures the distribution unit 122 in accordance with the desired operating mode. The computation unit 111 additionally provides a digital reference signal REF, which is supplied to the oscillator 121 via the digital/analog converter 114. This reference signal REF governs the oscillation frequency of the output signal OSZ of the oscillator 121, which is supplied to the distribution unit 122. For a measurement in the short range, the distribution unit 122 is configured in such a manner that the transmission signal is supplied only to the transmitting/receiving circuit 123a, which is activated by the control signal CT1. The second transmitting/receiving circuit 123b is deactivated by the control signal CT2. The transmitting/receiving circuits 123a and 123b also comprise a transmission amplifier output stage via which the transmission signal is supplied to the respective antenna modules 130a and 130b. The structure of the transmitting/receiving circuits 123a and 123b (RF frontends) and the advantage of amplifiers that are “locally” arranged in the respective transmitting/receiving circuits will be discussed later.

In addition, the transmitting/receiving circuit 123a contains one or more mixers with the aid of which the radar signals which are received by the receiving antennas are mixed to baseband. The baseband signal IF1 is then made available by the transmitting/receiving circuit 123a to the distributor block 112 in the control and processing unit 110. Depending on the number of receiving antennas, the baseband signal IF1 comprises a plurality of signal elements. The baseband signal IF1 is distributed by the distributor block 112 to an analog/digital converter 113, which has one or more channels, and is made available from this analog/digital converter 113 in digital form to the computation unit 111. This computation unit 111 can then use the digitized baseband signals IF1 to identify objects in the “field of view” of the radar, and to calculate the distance between them and the radar. This data is then made available via an interface, for example a vehicle bus BS, to the rest of the vehicle.

For a measurement in the long range, all that is necessary is switching in the distributor unit 122, activation of the transmitting/receiving circuit 123b and deactivation of the transmitting/receiving circuit 123a by means of the control signals CT0, CT1 and CT2. The transmission and reception then take place via the antennas 130b, which in the present case are in the form of common transmitting and receiving antennas. For this reason, in one embodiment a directional coupler is employed to separate the transmission signal and the received signal. What has been said for the first transmitting/receiving circuit 123a also, of course, applies analogously to the second transmitting/receiving circuit 123b. The detailed design of the transmitting/receiving circuits 123a and 123b will be explained with reference to a further figure.

The transmitting/receiving circuits 123a and 123b can be deactivated in various ways. In one embodiment, the circuits (or else only circuit elements) are disconnected from the supply voltage. It is also possible to switch off the mixers in the transmitting/receiving circuits. Irrespective of the specific manner in which the deactivation is accomplished, it is, however, necessary to ensure that the power of the transmission signal is not reflected, and therefore does not interfere with any other circuit components.

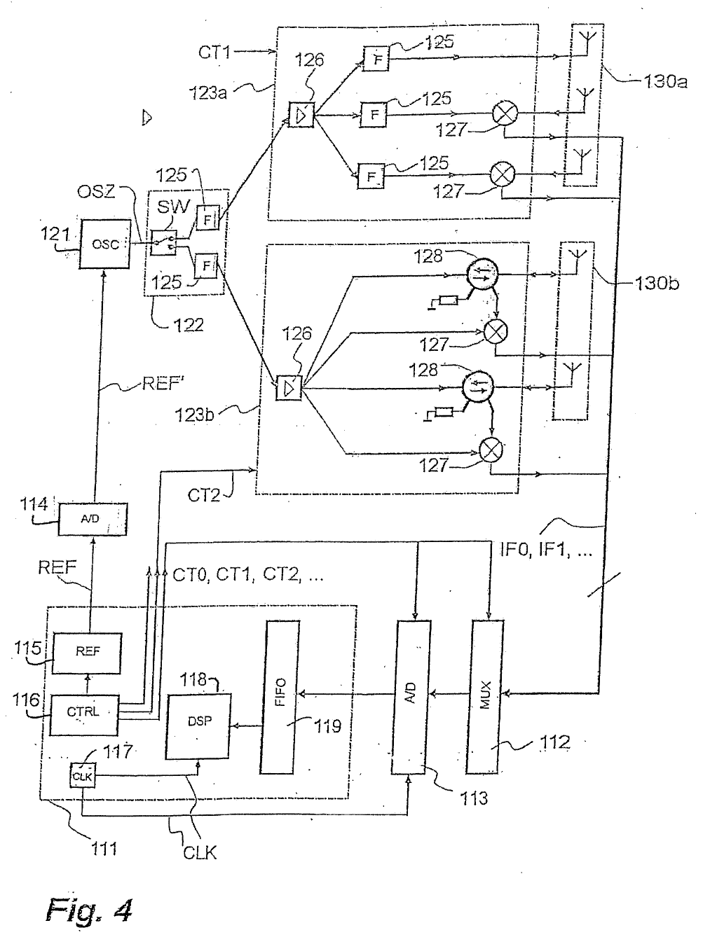

FIG. 4 shows one example of FIG. 3, with the computation unit 111, the distributor block 122 and the transmitting/receiving circuits 123a and 123b being illustrated in more detail. In one embodiment the transmitting/receiving circuits 123a and 123b each comprise an amplifier 126 to which the transmission signal is supplied. These amplifiers 126 have a plurality of outputs, at least one of which is connected to a transmitting antenna, and at least a second of which is connected to a mixer 127. If disturbing signals which have to be filtered out are present, a filter 125 may be in each case arranged between the amplifier 126 and the transmitting antenna, and between the amplifier 126 and the mixer 127. In the transmitting/receiving circuit 123a, the mixers 127 are connected not only to the amplifier 126 but also to the receiving antenna, so that the received signal is mixed to baseband by the mixer 127 with the aid of the transmission signal.

In the illustrated example, one transmitting antenna and two receiving antennas are provided in the antenna module 130a. This should be regarded only by way of example, and in principle any desired combination of transmitting and receiving antennas is possible. Instead of separate transmitting and receiving antennas, it would also be possible to use bidirectional antennas, as is the case with the antenna module 130b.

The transmitting/receiving circuit 123b differs from the transmitting/receiving circuit 123a described above in this embodiment by comprising the directional couplers 128 which allow the antennas in the antenna module 138 to be used both as transmitting antennas and as receiving antennas. The directional couplers 128 have four connections, of which a first connection is connected to the amplifier 126, a second connection is connected to a terminating impedance, a third connection is connected to a mixer 127 and a fourth connection is connected to one antenna of the antenna module 130b. The transmission signal is passed from the amplifier 126 through the directional coupler to the antenna, where the signal power is emitted from. A received signal is passed from the antenna through the directional coupler to the mixer 127, where it is mixed to baseband (or to intermediate frequency band respectively) with the aid of the transmission signal, which is likewise supplied to the mixer 127.

The output signals from the mixers, i.e. the baseband signals IF0, IF1 are then multiplexed by the distributor block 112, and are digitized by the analog/digital converter 113. These digitized signals are buffered in a FIFO memory 119 and are processed further by a digital signal processor (DSP) 118. The FIFO memory 119′ and the digital signal processor 118 are components of the computation unit 111, as is the clock generator (CLK) 117, which provides a clock signal for the digital signal processor 112 and for the analog/digital converter 113. The control logic (CTRL) 116 provides the control signals CT0, CT1 and CT2 and likewise controls a reference signal generator (REF) 115, which produces the digital reference signal REF for the oscillator (QSC) 121 (see above).

The distribution unit 122, which distributes the oscillator signal OSZ to the transmitting/receiving circuits 123a and 123b, has one switch SW in the illustrated embodiment, which may, for example, be in the form of a semiconductor switch or a micromechanical switch. This switch connects the oscillator 121 either to the first transmitting/receiving circuit 123a or to the second transmitting/receiving circuit 123b. Filters 125 are likewise arranged between the switch SW and the transmitting/receiving circuits 123a, 123b, provided that disturbing signals are present. It is also possible to connect the oscillator directly to the two transmitting/receiving circuits 123a and 123b (that is to say without the provision of a switch SW), or to provide a passive power splitter. The oscillator power is then split between the two transmitting/receiving circuits. As already mentioned, it is important in this case to prevent reflections when one of the transmitting/receiving circuits 123a, 123b is deactivated. Suitable terminating impedances must therefore be provided at an appropriate circuit node.

The example illustrated in FIG. 4 is designed for a so-called time multiplexing mode, i.e. switching takes place alternately from the first operating mode to the second operating mode, and back again. The frequency ranges for measurements in the near area (short range) in the first operating mode and for measurements in the far area (long range) in the second operating mode may overlap, since only one of the two antenna modules 130a or 130b is active.

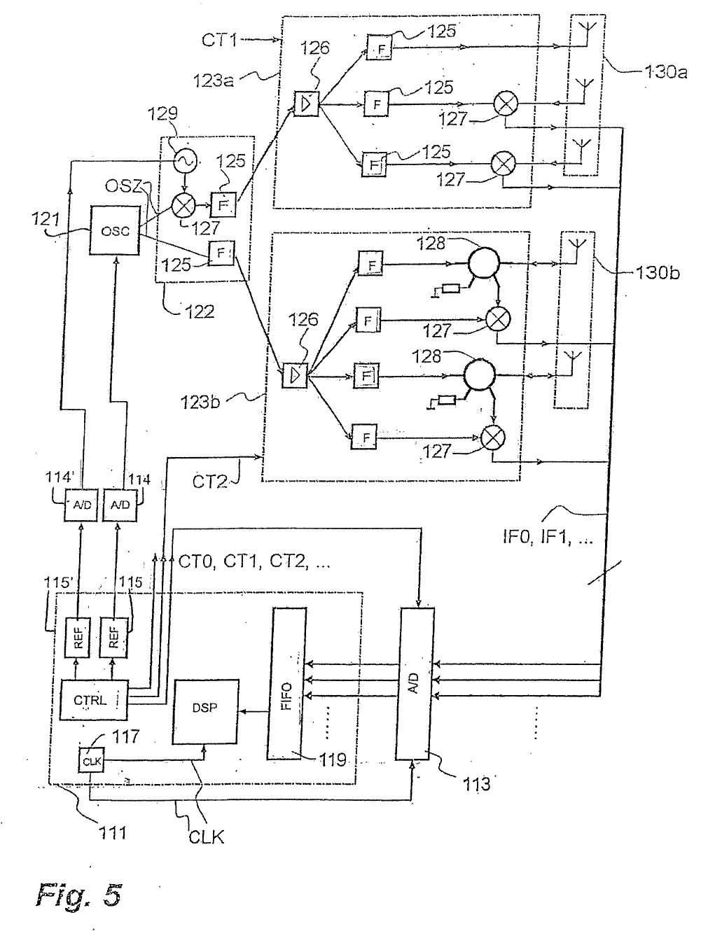

FIG. 5 shows another embodiment which operates using the frequency multiplexing mode. This differs from the exemplary embodiment shown in FIG. 4 only by having a modified distributor unit 122, the additional reference signal generator 115′ with the additional digital/analog converter 114′. Since measurements are carried out concurrently in the near area and in the far area in the frequency-division multiplexing mode, the multiplexer 112 may not be required in this case, but the analog/digital converters 113 would then have to comprise a plurality of channels in order to allow the received signals, which have been mixed to baseband, to be digitized in parallel.

In the example of FIG. 5, instead of a switch, the distributor unit 122 has an additional mixer 127 and an additional oscillator 129. The output signal OSZ from the oscillator 121 is on the one hand supplied to the mixer 127 in the distributor unit 122, and is on the other hand passed on via an optional filter 125 to the transmitting/receiving circuit 123b as well. The spectrum of the signal component of the oscillator signal OSZ supplied to the mixer 127 is frequency shifted by the oscillator frequency of the auxiliary oscillator 129, and is supplied via a filter 125 to the transmitting/receiving circuit 123a. The auxiliary oscillator 129 is likewise controlled by the computation unit 111 with the aid of the reference signal generator 115′ and the digital/analog converter 114′, which is connected to it and whose output signal is supplied to the auxiliary oscillator 129. The mixer 127 and the auxiliary oscillator 129 thus result in the production of a second, frequency-shifted transmission signal, so that the two transmitting/receiving circuits 123a can transmit and receive at the same at different frequencies via the two antenna modules 130a and 130b, respectively. This allows concurrent measurement in the near area and in the far area.

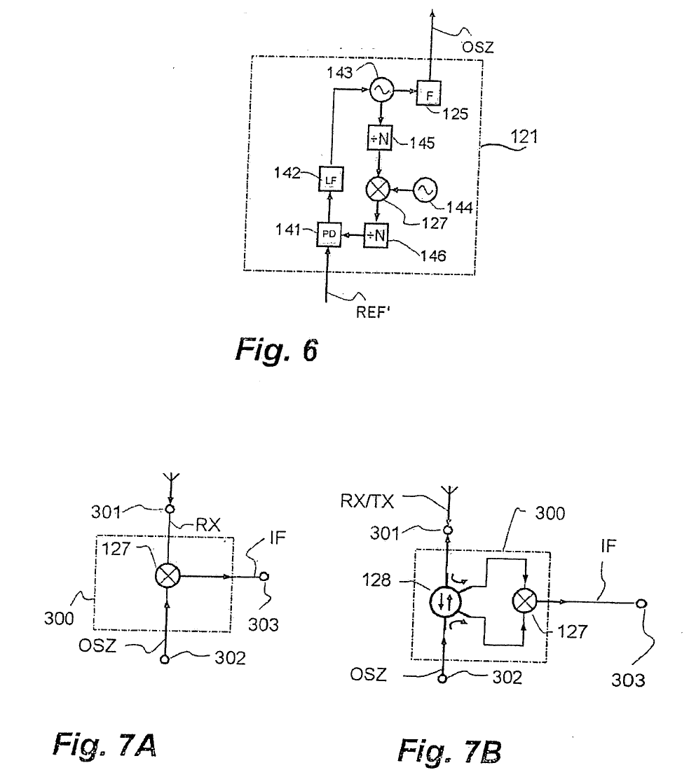

FIG. 6 shows one embodiment of the radio-frequency oscillator 121, with whose aid the transmission signal is produced. The oscillator comprises a phase locked loop (PLL) to which the analog reference signal REF′ which is produced by the digital/analog converter 114 is supplied. One element of the phase locked loop is a voltage-controlled radio-frequency oscillator 143 whose output signal is supplied on the one hand to a frequency divider 145, and on the other hand to a filter 125. The output signal from the filter 125 represents the output signal OSZ from the phase-locked loop. The output signal from the frequency divider 145 is supplied to a mixer 127 which uses an auxiliary oscillator 144 to shift the spectrum of the frequency-divided oscillator signal by the magnitude of the frequency of the auxiliary oscillator 144 towards a lower value. The output signal from the mixer is divided down once again by a further frequency divider 146. The output signal from this further frequency divider 146 thus represents the oscillator signal of the radio-frequency oscillator 143, which is compared with the previously mentioned reference signal REF′ with the aid of the phase/frequency detector 141. This phase/frequency detector 141 produces a control voltage as a function of the frequency and phase difference between the output signal from the frequency divider 146 and the reference signal REF′. This control voltage is supplied to a loop filter 142, whose output is connected to the voltage-controlled radio-frequency oscillator 143. The voltage-controlled radio-frequency oscillator 143 is thus dependent on the phase difference and/or frequency difference between the output signal from the frequency divider 146, which represents the oscillator signal, and the reference signal REF′. The phase and the frequency of the output signal OSZ from the phase locked loop thus have a fixed relationship with the phase and the frequency of the reference signal REF′. The voltage-controlled radio-frequency oscillator 143 must be tunable over a broad frequency range, in the present case in the range from 76 GHz to 81 GHz, that is to say over a bandwidth of 5 GHz. Since the mid-frequency can also be shifted by temperature effects and other parasitic effects, a bandwidth of 8 GHz or more is desired in practice, and this can be achieved only by using the modern bipolar or BiCMOS technology that has already been mentioned further above.

As it can be seen in FIGS. 3 to 5 the antennas 130, 130a and 130b may either configured to be used as receiving antennas, as transmitting antennas, or as common transmitting/receiving antennas. With “transmitting-only” antennas the transmitting signal TX is generated from the oscillator signal OSZ of the voltage control oscillator by amplification, and the transmitting signal TX is supplied to the antenna. With the “receiving-only” antenna a mixer 127 is needed for receiving, wherein the mixer is adapted for mixing a received signal RX into baseband and for providing the respective baseband signal IF. With a common transmitting/receiving antenna a directional coupler 128 is necessary for separating the received signal RX from the transmitting signal TX. The antennas—dependent on the application—may be arranged together with the RF front on one common lead frame in one common chip-package. FIG. 21 refers to such an example.

As it can be seen from the example of FIG. 4 or 5, the oscillator signal OSZ in the transmitting/receiving circuit 123b (123a respectively) is amplified for providing the necessary signal power. The amplified RF oscillator signal is than supplied to the antennas and the mixers, wherein at each component (splitter, coupler, mixer, etc.) reflections and losses occur, which has a negative impact on the efficiency of the overall system.

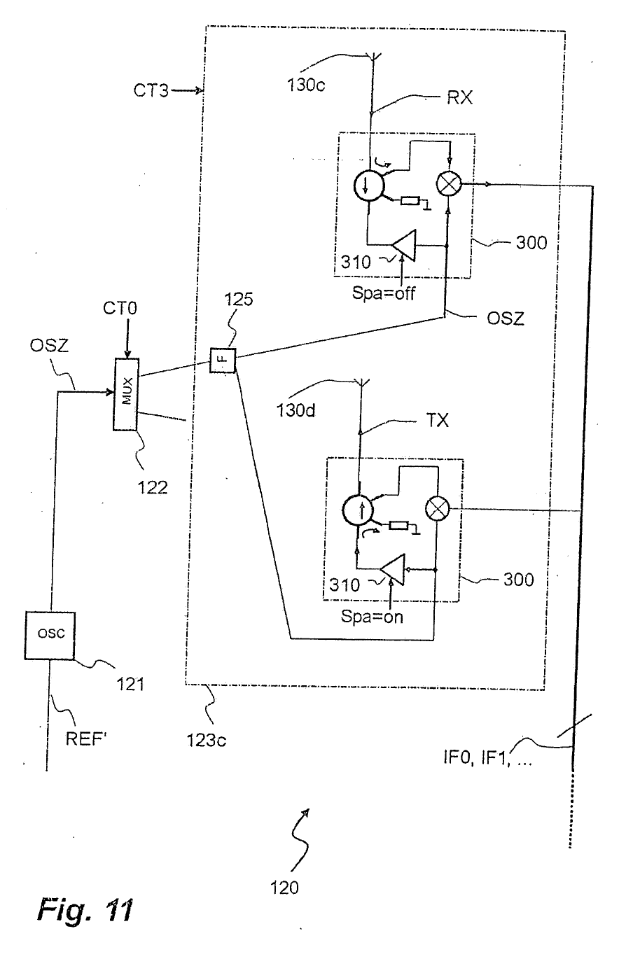

Several different mixer arrangements 300 each comprising a directional coupler 128 and a mixer 127 are illustrated in FIGS. 7A to 9C. Such mixer arrangements 300 may be used, for example for designing a transmitting/receiving circuit similar to circuit 123b. Each of these mix arrangements 300 comprises an RF terminal 301, an oscillator terminal 302, and a baseband terminal 303. The oscillator signal OSZ (or alternatively an amplified oscillator signal) is supplied to the oscillator terminal 302; the RF terminal is connected to the antenna, which either emits a transmitting signal TX and/or receives an receiving signal RX. At the baseband terminal 303 a baseband signal IF is provided for further processing, wherein the baseband signal IF is generated by mixing the received signal RX and the oscillator signal OSZ. A transmitting/receiving circuit comprising such mixer arrangements 300 is depicted in FIG. 11 and labeled with the reference sign 123c. The transmitting/receiving circuit 123c may replace the transmitting/receiving circuits 123a or 123b of FIG. 3 or 4 for improving the efficiency of the overall system.

The mixer arrangement 300 depicted in FIG. 7a comprises a mixer 127 as a primary component. A first input of the mixer 127 is connected with the oscillator terminal 302 of the mixer arrangement 300, the oscillator signal of the voltage controlled oscillator being supplied to the oscillator terminal 302. A second input of the mixer 127 is connected with the RF-terminal 301, the received signal RX of the antenna being supplied to the RF-terminal 301. An output of the mixer 127 is connected with the baseband terminal 303 thus providing a baseband signal IF. The mixer arrangement described above is employed for receiving.

If the antenna is used as a common transmitting/receiving antenna, a directional coupler 128 has to be provided as depicted in FIG. 7b. The mixer arrangement 300 of FIG. 7b comprises a directional coupler 128 and a mixer 127 as the primary components. The oscillator signal is supplied to the oscillator terminal 302 of the mixer arrangement 300; the oscillator terminal 302 is connected with a first terminal of the directional coupler 128.

The oscillator signal OSZ is coupled by the directional coupler 128 to both the antenna as well as the mixer 127 as indicated by the arrows in FIG. 7b. The directional coupler 128 thus couples the oscillator signal OSZ incident at its first terminal to a fourth terminal of the directional coupler 128 and to a second terminal of the directional coupler 128. The fourth terminal is connected to the RF-terminal 301 and therefore to the antenna 130. The second terminal is connected with the first input of the mixer 127.

A received antenna signal RX arrives at the fourth terminal of the directional coupler 128 via the RF terminal 301 and is coupled by the directional coupler 128 to the mixer 127 via the third terminal of the directional coupler 128. The mixer 127 generates the baseband signal IF from the received antenna signal RX and the oscillator signal OSZ and provides the baseband signal IF at the base-band terminal 303 for further processing, in one embodiment.

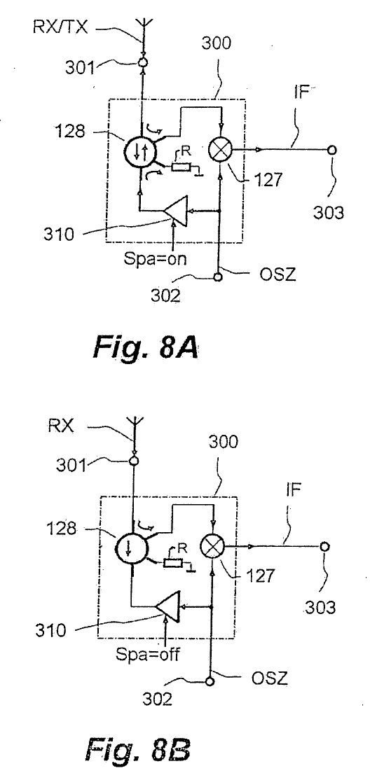

If the antenna configuration is to be varied or different applications require different system architectures (and therefore a different antenna- and mixer-configuration), then it is desirable, that these different mixer configurations do not require different hardware solutions, and that one mixer-hardware is configurable for a different applications. FIGS. 8a and 8b illustrate, according to one embodiment of the invention, a mixer arrangement which is configurable (by switching) for a “receiving only” mode and a common transmitting/receiving mode. FIG. 8a illustrates the configuration and the signal flow for the common transmitting/receiving mode and FIG. 8b for the receiving-only mode.

The configurable mixer arrangement 300 of FIGS. 8a and 8b comprises a directional coupler 128, a mixer 127, a terminating impedance R, and a switchable, respectively configurable amplifier 310. Analogues to the mixer arrangements of FIGS. 7a and 7b the mixer arrangements 300 of FIGS. 8a and 8b comprise an RF-terminal 301, an oscillator terminal 302, and a baseband terminal 303. The RF-terminal 301 is connected with both the antenna and the fourth terminal of the directional coupler. The oscillator terminal 302 is connected with both the input of the amplifier 310 and the first input of the mixer 127, such that the oscillator signal OSZ, which is received by the oscillator terminal 302, is coupled to the mixer 127 as well as to the amplifier 310. The baseband terminal 303 is connected to the output of the mixer.

The output of the amplifier 31Q is connected with the first terminal of the directional coupler 128. In the embodiment of FIGS. 8A and 8B the amplifier 310 can be enabled (Spa=on) and disabled (Spa=off) by a control signal Spa. The control signal Spa can assume two logic levels (on or off), according to which the amplifier is either activated or deactivated. With an activated amplifier 310 the oscillator signal is amplified and coupled to the fourth terminal of the directional coupler 128 and emitted as transmitting signal TX via the antenna. A part of the power of the oscillator signal is coupled to the terminating impedance R via the second terminal of the directional coupler 128. This terminating impedance R has to be chosen, such that no signal power is reflected.

The received signal RX received by the antenna is coupled via the directional coupler 128 (as indicated by the arrows) to the second input of the mixer 127, where the received signal RX is mixed with the oscillator signal OSZ for providing a base-band signal IF. A part of the signal power of the received signal RX is coupled via the directional coupler 128 to the output of the amplifier 310. The received signal RX has to be terminated at the amplifier output by means of a suitable terminating impedance for inhibiting undesired reflections.

FIG. 8b illustrates the embodiment where the mixer arrangement 300 is configured as receiving-only mixer. Therefore, the amplifier 310 is deactivated by a corresponding level (Spa=off) of the control signal Spa and no transmitting signal is coupled to the antenna. The received signal RX is processed analogue to the embodiment shown in FIG. 8a.

The mixer arrangements depicted in FIGS. 8a and 8b allow for a configuration of the operating mode of the mixer arrangement by a control signal Spa, the operating mode can be either the combined transmitting/receiving mode, or the receiving-only mode. Consequently, the same hardware component can be used with different system configurations. This is especially useful for chips comprising a plurality of mixer arrangements which are employed in different system configurations.

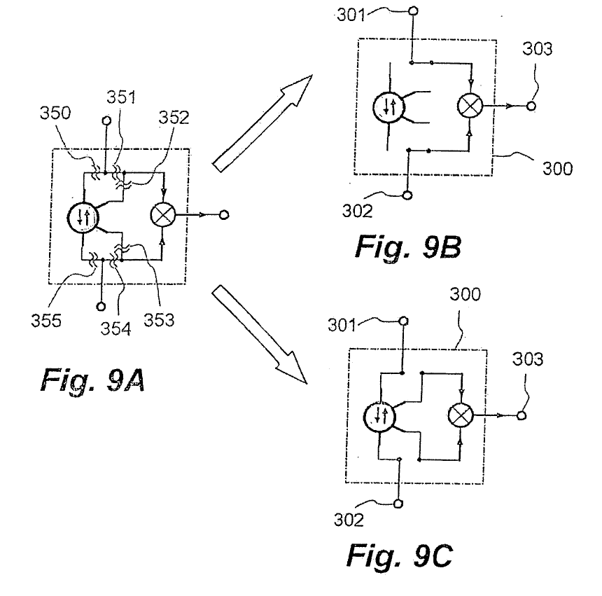

The embodiment illustrated in FIGS. 9a, 9b and 9c does not allow a repeatable configuration of the mixer arrangement 300 by means of a control signal, but only a configuration being performed once by fusing laser fuses 350 to 355, or by depositing an optional (maybe final) metallization layer thus providing the last missing electrical connections. FIG. 9a illustrates the initial configuration, starting from which the arrangement of FIG. 9b or the arrangement of FIG. 9c is produced. The arrangement of FIG. 9b corresponds to the arrangement of FIG. 7a, and the arrangement of FIG. 9c corresponds to the arrangement of FIG. 7b.

In order to get a receiving-only mixer (cf. FIG. 7a or FIG. 9b) from the initial configuration, the fuses 350, 352, 353, and 355 are fused, for example by a laser-beam during the production process. In order to get a combined transmitting/receiving mixer (cf. FIG. 7b or FIG. 9c), the fuses 351 and 354 are fused.

Instead of laser fuses 350 to 355 intermittent signal paths in the metallization layer can be used. At the places, where in the case described above the fuses are not fused, the interruptions of the signal paths are closed by disposing a further metallization at the place of the interruptions in the signal paths (e.g. strip lines).

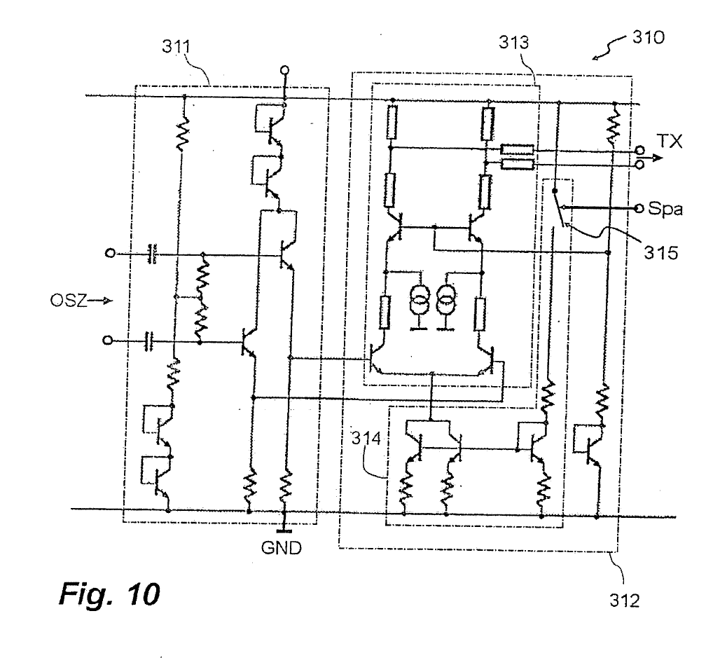

FIG. 10 illustrates one embodiment of an amplifier which can be activated or deactivated by a control signal Spa. The oscillator signal OSZ and the transmitting signal TX are differential signals, i.e. signals which are not ground related, in the example of FIG. 10. The oscillator signal OSZ is supplied to two corresponding terminals as indicated by the arrow. The first stage 311 of the amplifier is an emitter follower, whose output signal is again amplified by the differential amplifier 313. The current mirror 314 thereby serves as current source for the differential amplifier 313. By switching of the current source the amplifier may be deactivated. In order to do so, for example a switch may be provided which switches off the current in the reference path of the current mirror 314. The output signal (transmitting signal TX) is provided at the two corresponding output terminals as a symmetric, i.e. differential, signal. FIG. 11 illustrates a further a transmitter/receiver front-end 120, which serves as an alternative embodiment or supplement to the transmitter/receiver front-ends 120 depicted in FIGS. 3 to 5. The transmitting/receiving circuits 123a and 123b of FIGS. 4 and 5 may be replaced by the sending/receiving circuit 123c of FIG. 11, which substantially provides the same function.

The transmitter/receiver front-end 120 of FIG. 11 may comprise an RF-oscillator (e.g. a voltage controlled local oscillator) which provides an oscillating signal OSZ depending on the analog reference signal REF′ (cf. FIG. 4). The oscillator signal QSZ is supplied to the distribution unit 122 which distributes the single power, dependent on the mode of operation, to the connected transmitting/receiving circuit. In the present case only one transmitting/receiving circuit 123c is depicted for the sake of simplicity and clarity. Of course two or more transmitting/receiving circuits can be connected to the distribution unit 122 (cf. FIGS. 3 to 5).

The transmitting/receiving circuit 123c comprises an optional filter 125, whose output is connected to one or more of the mixer arrangements 300 described with reference to FIGS. 8a and 8b. Instead of the (multi-output) filter 125 a further distribution unit (RF-splitter) or a simple parallel connection of the mixer arrangements 300 may be used as alternatives. The mixer arrangement is connected with one or more antennas 130 and provides the baseband signals IF0, IF1 by mixing the received signals RX with the oscillator signal OSZ.

One difference between the present example and the example illustrated in FIGS. 4 and 5 is, that the RF-transmitting signal is not once “centrally” amplified before being distributed to the different signal paths each corresponding to an antenna (as performed, for example, by the circuit 123b of FIG. 4), but the amplification is performed “locally” in each mixer arrangement 300 after the distribution of the un-amplified (low power) RF-transmitting signal. This entails a substantial improvement of the efficiency of the overall RF front-end 120 and an improvement in flexibility. Only un-amplified RF signals are distributed to different signal paths and since the amplification is performed in each signal path closely to the antenna, the losses in the splitters, mixers, couplers, etc. are substantially reduced. Since the mixer arrangements 300 are configurable via a control signal Spa (which may depend or may be deducted from the control signal CT3), the overall system is also improved in terms of scalability.

Most of the above-described RF-frontends and mixer arrangements that comprise directional couplers (cf. FIGS. 4, 5, 8, and 11) have a terminating impedance connected to the directional coupler, thus avoiding reflections. In the following discussion it will be explained how a specific mismatch of the terminating impedance connected to a port of the directional coupler is utilized to avoid an undesired DC signal offset at the output of the mixer.

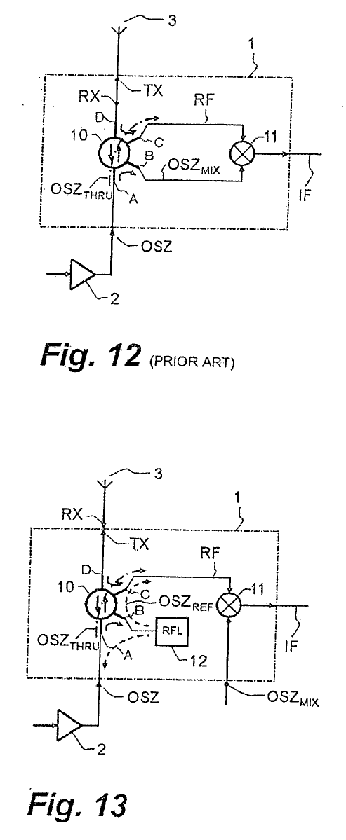

FIG. 12 illustrates an RF circuit for transmitting and receiving RF signals (RF front-end 1) comprising a conventional directional coupler 10 and a mixer 11. The directional coupler 10 is, in one embodiment, a rat race coupler having four inputs/outputs which are usually called ports (A, B, C, D). In the following, a first port of the directional coupler 10 is referred to as “first oscillator port” A. An oscillator signal OSZ is provided to the first oscillator port A, the oscillator signal OSZ being generated, for example, by a local RF oscillator and being amplified by an RF amplifier 2. The second port of the directional coupler 10 is referred to as “second oscillator port” B. This port is connected with the oscillator input of the mixer 11. The third port of the directional coupler 10 is referred to as “second RF port” C, which is connected to a signal input of the mixer 11. The fourth port of the directional coupler is referred to as “first RF port” D, which can be connected to an antenna 3.

The oscillator signal OSZ supplied to the first oscillator port A of the directional coupler 10 is, on the one hand, to be transmitted by the antenna 3 as a transmit signal TX, and, on the other hand, is used as a mixer signal OSZ_{MIX} for mixing the signals received from the antenna 3 into the baseband or the IF-band. For this purpose the directional coupler is designed such that a signal incident at the first oscillator port A is coupled to the second oscillator port B as well as to the first RF port D. The second RF port C should be isolated against a signal incident at the first oscillator port A. In the figures the coupled ports are labeled with arrows having a solid line. The direction of the arrows indicates the direction of the signal flow.

During operation of the RF front-end an antenna signal RX received by the antenna 3 is incident at the first RF port D of the directional coupler 10 and is coupled to the second RF port C as a receive-signal RF and to the first oscillator-port A. The receive-signal RF is thus supplied to the signal input of the mixer 11, and down-mixed to the IF-band (or baseband) with the help of the mixer signal OSZ_{MIX}. The resulting IF-signal (or baseband signal) IF is provided at an output of the mixer 11 for further processing. A part of the antenna signal RX is typically coupled back to the first oscillator port A. This part of the antenna signal RX should be terminated by an adequate terminating impedance for avoiding undesired reflections. This terminating impedance may be, for example, arranged at the output of the RF power amplifier.

A real directional coupler does not have ideal properties in terms of through-loss and isolation of its ports. The oscillator signal OSZ incident at the first oscillator port A, for example, is not only—as desired—coupled to the second oscillator port B and to the first RF port D, but a small part of the signal is also coupled to the second RF port C due to parasitic effects. This small part of the oscillator-signal OSZ which is undesirably coupled to the second RF port C is labeled by the reference symbol OSZ_{THRU} and indicated by an arrow having a dash-dotted line. The parasitic signal OSZ_{THRU} superimposes at the signal input of the mixer 11 the receive-signal RF which stems from the antenna 3. A DC signal-offset at the mixer output is caused by the undesired, parasitic signal OSZ_{THRU} when mixed with the mixer signal OSZ_{MIX}, the DC 36′ signal offset superimposing the resulting IF-signal. The greater this DC signal-offset, the higher the power of the oscillator signal OSZ to be transmitted.

The DC signal offset leads to problems especially when using active mixers, since it limits the transmittable power. In radar applications a limitation of the transmittable power is equal to a limitation of the field of view of the radar sensor.

FIG. 13 illustrates one embodiment of the invention comprising an RF front-end circuit 1 with a mixer 11, a directional coupler 10 and a reflection circuit 12 which is connected to the directional coupler 10. An oscillator signal OSZ which is to be transmitted is supplied to the first oscillator port A of the directional coupler 10. The directional coupler 10 couples this signal as transmit-signal TX to the first RF port D, where it can reach the antenna 3, and to the second oscillator port B which is, in the present example, connected to the input of a reflection circuit 12. The signal part of the oscillator signal OSZ which is coupled to the second oscillator port B by the directional coupler 10 is thus supplied to the input of the reflection circuit 12.

The second RF port C is, as illustrated in FIG. 12, connected to the signal input of the mixer 11. An antenna signal RX incident at the first RF port D is coupled to the second RF port C as a receive signal RF and is thus supplied to the signal input of the mixer 11. In the present embodiment the mixer signal OSZ_{MIX} supplied to the oscillator input of the mixer 11 is an external signal supplied to the RF front-end circuit. The mixer signal OSZ_{MIX} is, for example, derived from the oscillator signal OSZ by means of an external power divider (not shown).

The input of the reflection circuit comprises a complex input impedance whose value is chosen such that a part OSZ_{REF} of the oscillator signal is reflected. The phase and the absolute value of the reflected part OSZ_{REF} of the oscillator signal depend on the input impedance of the reflection circuit 12. This reflected part OSZ_{REF} of the oscillator signal is incident at the second oscillator-port B of the directional coupler 10 and thus coupled to the second RF port C (illustrated by the arrow with the dashed line), such that it destructively superposes or interferes with the parasitic oscillator signal OSZ_{THRU} coupled directly from the oscillator port A to the second RF port C. An optimally adjusted complex input impedance of the reflection circuit 12 allows for complete elimination of the parasitic oscillator signal OSZ_{THRU} at the signal input of the mixer 11 which is connected to the second RF port C, thus eliminating the undesired DC offset at the output of the mixer 11.

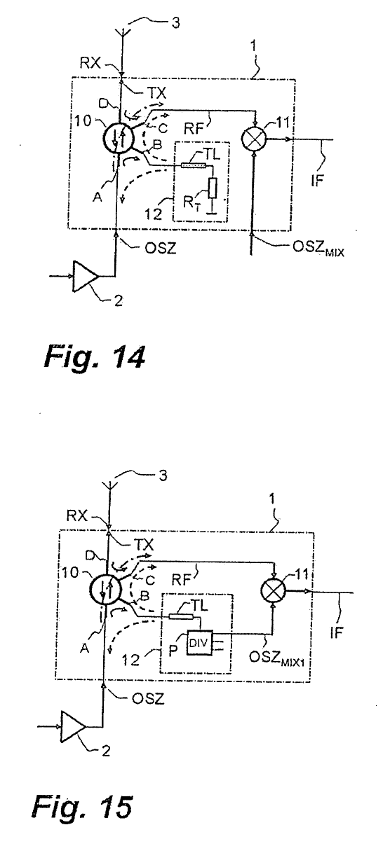

One embodiment of the reflection circuit 12 is depicted in FIG. 14. In this embodiment the reflection circuit 12 comprises a delay line TL and an ohmic resistance R_{T} being connected with the delay line TL. The delay line TL and the resistance R_{T} may be, for example, connected in series between the second oscillator port B of the directional coupler 10 and a reference potential (e.g., ground). The input impedance of the reflection circuit 12 illustrated in FIG. 14 is determined by the delay time of the delay line TL and by the value of the resistance R_{T}, wherein the resistance R_{T} essentially determines the real part of the input impedance and therefore the absolute value of the reflected part OSZ_{REF} of the oscillator signal, whereas the delay line TL determines the phase of the reflected part OSZ_{REF} of the oscillator signal.

FIG. 15 illustrates a modified version of the RF front-end circuit 1 of FIG. 14, where the resistance R_{T} of the reflection circuit 12 is formed by the input impedance of a power divider P. Analogous to the example of FIG. 14 a part of the signal incident at the input of the reflection circuit 12 is reflected and coupled to the second RF port C such that the reflected part OSZ_{REF} of the signal is destructively superimposed at the signal input of the mixer 11 with the parasitic oscillator signal OSZ_{THRU} which is coupled from the first oscillator port A to the second RF port C. Compared to the example of FIG. 14 the power divider P allows for using the oscillator signal OSZ_{MIX}, which is coupled to the second oscillator-port B of the directional coupler 10, as mixer signal for the oscillator input of the mixer 11. In the present example the output signal OSZ_{MIX1} of the power divider P is supplied to the oscillator input of the mixer 11. Such a configuration has the advantage that—in contrast to the example of FIG. 14—the mixer signal OSZ_{MIX1} is not supplied from outside of the RF front-end circuit 1.

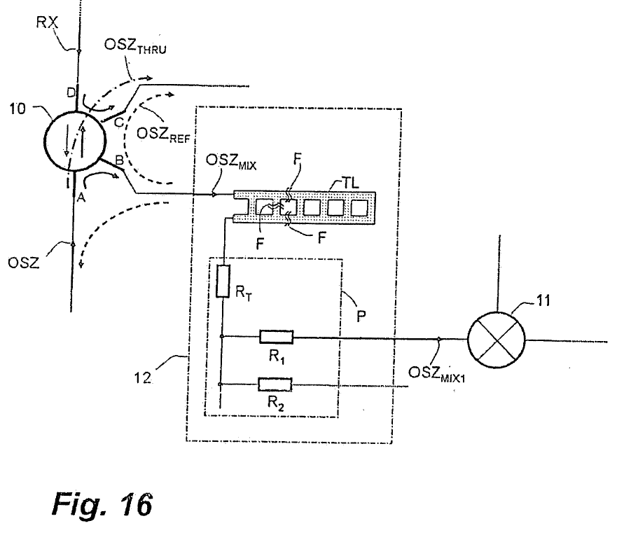

An exemplary realization of a strip line TL and the power divider P of the reflection circuit 12 is illustrated in more detail in FIG. 16. The oscillator signal OSZ incident at the first oscillator port A of the directional coupler 10 is coupled to the second oscillator port by the directional coupler 10 and therefore to the input of the reflection circuit 12. This input signal of the reflection circuit 12 is denoted with OSZ_{MIX} in this example. An output of the power divider P provides a mixer signal OSZ_{MIX1} derived from the input signal OSZ_{MIX}. The mixer signal OSZ_{MIX1} may be supplied to the oscillator input of the mixer 11 as shown in the example of FIG. 15.

The delay line TL illustrated in FIG. 16 comprises at least two parallel microstrip lines which are connected by short-circuits at several positions thus forming a “ladder-shaped” structure, where the short-circuits are the “rungs” of the ladder-shaped structure. The two parallel microstrip lines may be separable at positions between the short-circuits as well as the short-circuits themselves. The “separation” of the microstrip lines may be performed by melting the lines with a laser beam such that they are disjoined. The separable positions of the microstrip lines and of the short-circuits are then usually referred to as “laser-fuses” F. As it can be seen from FIG. 16 the length of the delay line TL depends on which laser fuses are disjoined. Dependent on the length of the microstrip lines and on the number of short-circuits between the microstrip lines a plurality of possible lengths for the delay line TL exist. The necessary phase for the reflected signal OSZ_{REF}, and therefore the necessary length of the delay line TL, can be determined empirically and the length of the delay line TL can be adjusted by disjoining certain laser-fuses. The power divider which is connected to the delay line may be implemented as a passive electronic component in the present embodiment having a first resistor R_{T} and one or more further resistors R₁, R₂. A first terminal of the first resistor R_{T} is connected to the delay line TL. The first resistor usually determines the real part of the input impedance of the reflection-circuit 12 and therefore the absolute value of the reflected signal OSZ_{REF}. For exactly adjusting the value of the first resistor R_{T} the resistor can be tuned by means of a laser beam during the production process. A second terminal of the first resistor R_{T} is connected with the further resistors R₁, R₂ which are connected between the first resistor R_{T} and one of the outputs of the power divider respectively. In one embodiment the ratio of the further resistors R₁, R₂ essentially determines the power ratio of the power divider P.

Analogous to the delay line TL the directional coupler 10 may be realized by microstrip lines in one embodiment. In this case the entire RF front-end may be integrated in a single chip, if applicable together with further RF components like the antenna 3. Such chip design allows for the production of compact and cost effective radar systems, especially for the use in automobiles.

In the embodiment explained with reference to FIG. 16 the absolute value and the phase of the input impedance of the reflection circuit 12 is adjusted by means of the delay line TL and the ohmic resistance R_{T}. By adjusting the delay time of the delay line TL and the value of the resistor R_{T} separately, the absolute value and the phase of the input impedance and thus the absolute value and the phase of the reflected signal can be adjusted separately. This is to be understood as an example wherein it is also possible to adjust the real part and the imaginary part of the input impedance separately in other implementations which, for example, may comprise a parallel circuit of a capacitance (e.g. a varactor) and a (e.g. electronically adjustable) resistor. Generally the input impedance may be a more complex network comprising resistive and capacitive components of which at least some are electronically adjustable.

An electronically adjustable resistor could, for example, be implemented by means of a pin-diode (P-intrinsic-N diode) or by means of the corrector-emitter-path of a bipolar transistor for the drain-source-path of a field effect resistor, respectively. However, the actual implementation still depends on the manufacturing process.

Electronically variable components for electronically adjusting the terminal impedance at the second oscillator port B can be an alternative to laser-separable components. The adjusting of the phase which may be done by adjusting the length of a delay line in the embodiment of FIG. 16, can also be realized by an electronically variable delay line comprising, for example, a varactor. This provides the advantage, that the input impedance of the reflection-circuit 12 can not only be adjusted once, during the manufacturing process, but also during operation of the RF front-end. This is especially useful for compensating drifts of electrical properties of the directional coupler or the reflection circuit.

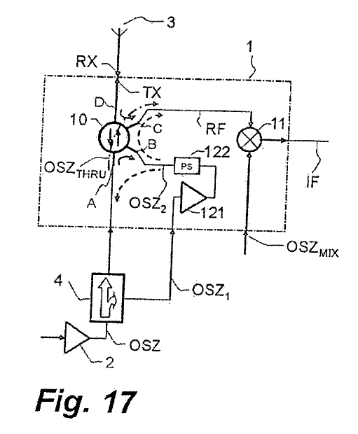

FIG. 17 shows a further embodiment of the RF front-end. The RF front-end 1 of FIG. 17 differs from the embodiment of FIG. 14 in that an amplifier 121 and a phase shifter 122 are connected to the second oscillator B. In contrast to the previous embodiments, the oscillator signal OSZ coupled from the first oscillator port A to the second oscillator port B is not reflected, but a compensation signal OSZ₂, which is amplified and phase-shifted with respect to the oscillator signal OSZ, is supplied to the second oscillator port B such that this compensation signal OSZ₂ is at least partially coupled to the second RF port C by the directional coupler 10 where it destructively superposes the parasitic signal OSZ_{THRU} which is directly coupled from first oscillator port A to the second RF port C. Thus the same effect, namely the (at least partial) elimination of the parasitic signal OSZ_{THRU} directly coupled from the first oscillator port A to the second RF port C, is achieved as it is explained with respect to the above-described embodiments comprising a reflection-circuit 12.

A part OSZ₁ of the oscillator signal OSZ which may be derived, for example, from the oscillator signal OSZ by means of another power divider 4 is supplied to the amplifier 121. The output of the amplifier is connected to the second oscillator port B via the phase-shifter 122. The gain of the amplifier 121 and the phase-shift of the phase-shifter 122 are adjusted such, that the part of the output signal OSZ₂ of the phase-shifter which is coupled from the second oscillator port B to the second RF port C compensates for the parasitic signal OSZ_{THRU} by a destructive superposition. The part of the output signal of the phase-shifter 122 which is coupled back to the first oscillator port A has to be terminated at an adequate position for avoiding undesirable reflection. The position of the amplifier 121 and the phase-shifter 122 may of course be interchanged.

The amplifier 121 may be a variable gain amplifier. The phase-shift of the phase-shifter 122 may be also adjustable. Therefore the phase-shifter may, for example, comprise varactors. If the gain of the amplifier 121 and the phase-shifter, the phase-shifter 122 are electronically adjustable, it is possible to adjust the RF front-end during operation such that no DC-offset occurs at the output of mixer 11 or at least such that the offset is kept as small as possible.

Alternatively, the absolute value and the phase of the compensation signal OSZ₂ fed into the second oscillator port B can also be adjusted by means of a quadrature mixer. In this embodiment the quadrature mixer takes over the function of the series circuit of amplifier 121 and phase-shifter 122 of FIG. 17.

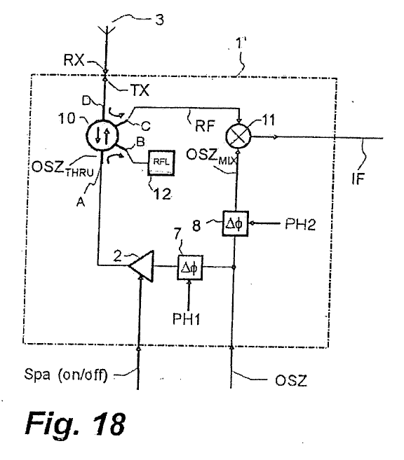

A further mixer arrangement 1′ is illustrated in FIG. 18. The mixer arrangement comprises, compared to the mixer arrangement of FIG. 13, the features of the mixer arrangement of FIG. 8 (local, switchable amplifier) and furthermore a first and a second electronic phase shifter 7, 8.

An oscillator signal OSZ of an RF local oscillator (cf. FIG. 11) is, on the one hand, supplied to the first RF-port of the directional coupler 10 for being coupled to the antenna via the first phase shifter 7 and the local RF amplifier 2, and, on the other hand, supplied to the mixer 11 via the second phase shifter 8. Thus, the mixer signal OSZₘᵢₓ may be a phase shifted version of the oscillator signal OSZ, and the transmit signal TX may be an amplified and phase shifted version of the oscillator signal OSZ. The phase shift of the phase shifter 7 and 8 may be electronically adjustable, for example, by means of a microcontroller. There are many options for implementing electronic phase shifters, for example, by means of MEMS (Micro Electromechanical Systems) or by means RC-delay elements, where the phase shift is adjustable by varying a capacitance. Electronically variable capacitors may comprise varactors (variable capacitance diodes). Alternatively, IQ-modulators may be used for implementing an electronic phase shifter.

If an antenna array is to be driven by means of the plurality of mixer arrangements 1′ providing transmit signals of different phases for achieving a certain antenna characteristic (phased array antenna), the first phase shifter 7 allows for compensating for variations of antenna positions due to tolerances of the manufacturing process.

When receiving the radar signal RX the problem may arise, that the received signal RX, when down-mixed into the base band, may have a low amplitude or a low signal power respectively, not only if the received signal power is low, but also if the received signal RF and the mixer signal OSZ_{MIX} are (at least approximately) orthogonal. However, it can not be distinguished, whether the received signal actually has a low amplitude or signal power, or is just orthogonal to the mixer signal OSZ_{MIX}. To avoid this problem, the mixer signal OSZ_{MIX} in one embodiment is alternately phase shifted by 0° and 90° by means of the second phase shifter 8, thus generating alternately the inphase and the quadrature component of the received and down-mixed base band signal.

Consequently, the complex amplitude (comprising the inphase and the quadrature component) of the received signal can be easily determined. If such a mixer arrangement is used, for example in the radar system of FIG. 3, the desired phase shift values may be calculated and provided by the control and processing unit 110, which may be a microcontroller or a digital signal processor.

Alternatively, the second phase shifter 8 may be connected with the RF-input of the mixer 11 instead of the oscillator-input of the mixer 11. The second phase shifter 8 is then disposed in the path between the directional coupler 10 and the RF-input of the mixer 11.

The above-mentioned generation of the inphase and the quadrature component of the received signal by alternately supplying the mixer with an oscillator signal being phase shifted by 90° is also applicable in a receive-only circuit. In this case the directional coupler 10 is not needed. Such a receive-only front-end comprises at least an input for an oscillator signal OSZ, an antenna 3 for receiving a signal RX and a mixer 11 for down-mixing the received signal RX into a intermediate frequency band or a base band, the mixer comprising a RF-input, an oscillator-input and an output. The receive-only front-end further comprises a phase shifter being connected between the input for the oscillator signal OSZ of the front-end and the oscillator-input of the mixer 11, whereby the phase shifter 8 is configured to alternately provide a phase shift of 0° and 90°, thus alternately providing at the output of the mixer the inphase and the quadrature component of the received signal RX down-mixed into the base band or an intermediate frequency band.

If a plurality of single-chip RF frontends is arranged on a substrate, e.g. a printed circuit board, then a phased antenna array for digital beam forming may be easily implemented because of the flexible phase control as described in the above example.

Antenna structures are used in a variety of applications. Communication devices are equipped with antennas to enable wireless communication between devices in network systems such as wireless PAN (personal area network), wireless LAN (local area network), wireless WAN (wide area network), cellular network systems, and other types of radio systems.

With conventional radar, radio or wireless communications systems, discrete components are individually encapsulated or individually mounted with low integration levels on printed circuit boards, packages or substrates. This usually causes significant losses at those high operating frequencies. At the same time, the miniaturization of the systems becomes more important, as robustness and reliability are required in the respective environments. Accordingly, there is a desire to package these electronic devices more densely. This, however, poses a number of challenges to designers, as high frequency appliances have to be integrated in hermetically closed packages while at the same time minimizing degrading effects on the emission characteristics and efficiency of the applied antennas.

A further aspect of the invention relates to a technology to integrate antenna structures into a package and to improve the emission behavior of a radar antenna structures which are encapsulated in a package.

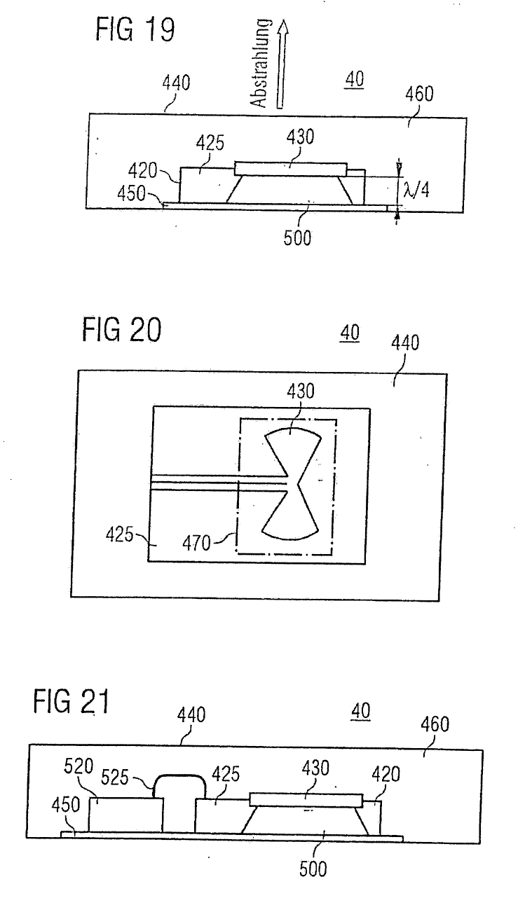

FIG. 19 illustrates an electronic apparatus 40 having an antenna chip 420 with a substrate 425 and an antenna structure 430. The antenna chip 420 is integrated or packaged in a package 440 having a conducting chip mounting surface 450 for mounting the antenna chip, and an encapsulating material 460. The encapsulating material may be, but is not limited to a typical plastic mold used in the industrial packaging of integrated circuits. Between the antenna structure 430 and the chip mounting surface 450, a first void 500 is arranged in the substrate 425 in the vicinity of the antenna structure 430. The substrate height may be adjusted to the individual operating wavelength. Preferably, substrate height is a quarter of the operating wavelength (λ/4) to support radiation in the direction of the front side of the antenna chip. Such an antenna arrangements may be used as antenna 130, 130a, 130b, etc. in the radar, systems of FIGS. 1 to 5 and 11.

The antenna structure 430 may be formed of any suitable material or combination of materials including, for example, dielectric or isolative materials such as fused silica (SiO₂), silicon nitride, imides, PCB as supporting and/or embedding material and conducting materials like aluminium, copper, gold, titanium, tantalum and others or alloys of those conductors as active antenna materials. The antenna substrate 425 may be formed of semiconductor materials such as silicon, GaAs, InP, or GaN, especially if further circuit components are to be integrated into the antenna chip 420. Other types of substrate like glass, polystyrene, ceramics, Teflon based materials, FR4 or similar materials are also included.

FIG. 20 shows a top sectional view of the above described example. The shape of the antenna structure 430 should be regarded as an example and as non-limiting. The antenna structure 430 may take the form of a variety of antenna types like Patch, Folded Dipole, Butterfly, Leaky wave, etc.

At least one void 500 adjacent to an antenna structure significantly improves the emission and/or receiving characteristics of the antenna and thus allows for reducing the applied power to achieve a certain radiated power or in case of receiving allows for a improved signal to noise figure. At the same time, homogeneity of the field distant from the antenna is improved. Furthermore, the electronic apparatus 40 allows for a dense package of the antenna structure which leads to the further miniaturization of the overall systems which use the antenna structure. Despite the dense package the emission and/or receiving characteristics of the antenna is improved and the mechanical robustness and reliability of the antenna structure can be guaranteed.

The first void 500 may be produced by etching the substrate 425 under the antenna structure 430. In case of silicon substrates the first void is preferably formed by a bulk etching process from a bottom surface of the substrate opposite to the antenna structure. The silicon bulk etching process can be performed by using a TMAH of KOH wet etch process or a plasma etching to etch off the bulk silicon.

The first void 500 typically has a size similar or larger to that of the antenna structure 430. Preferably, when the shape of the first void is projected vertically on the antenna structure, it is about 1/10 larger than the biggest dimension of the antenna. Voids which are significantly larger than the antenna structure may also be used. The void may also be segmented, e.g. to improve mechanical stability of the assembly.

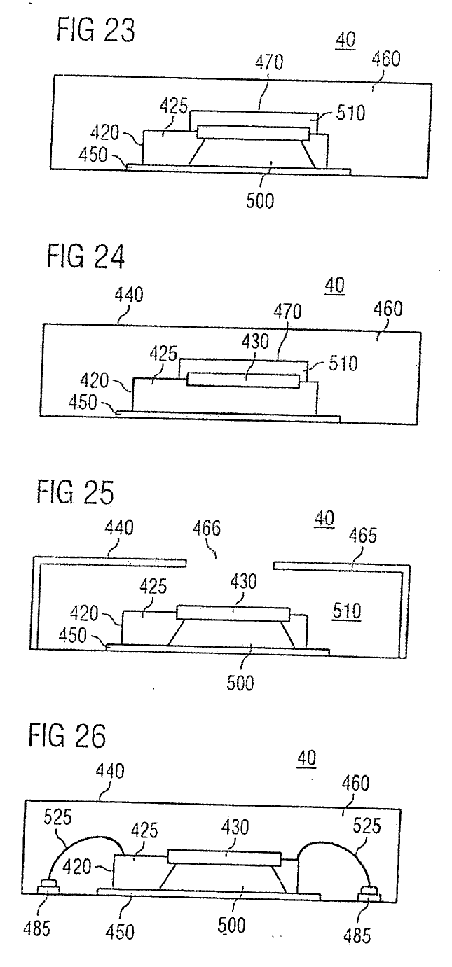

In a further example shown in FIG. 23, the electronic apparatus further comprises a second void 510 disposed between the antenna structure 430 and the encapsulating material 460. The second void serves to improve the emission characteristics of the antenna, as without a void the encapsulating material or mold would be in direct contact with the antenna structure, which might worsen the emission/receiving characteristics.

There are a variety of options to realize a second void. In one exemplary embodiment, an additional cap 470 is placed on the antenna structure 430 before the packaging of the apparatus, i.e. prior to the application of the encapsulating material 460 or mold mass. A suitable cap for this purpose is for example a SU8 frame. In a further exemplary embodiment, the second void is realized by using the encapsulation material in the form of an encapsulating lid 465 that is not in direct contact with the antenna chip 430.

Another example is shown in FIG. 21. Accordingly, the electronic apparatus further comprises a high frequency circuit chip 520 mounted to the chip mounting surface 450 of the package 440. The circuit serves to provide signals to the antenna structure 430 and to receive signals from it. It may comprise further electronic parts and components necessary to realize a radar, radio or wireless communication system in combination with the antenna structure, i.e. oscillators, mixers, frequency dividers, etc.

In the example illustrated in FIG. 21 the high frequency circuit chip 520 and the antenna chip 430 are connected with wirebonds interconnects 525. In a further example the high frequency circuit chip 520 and the antenna chip 430 are connected with bumps in a flip chip configuration. For example the high frequency circuit chip 520 might be placed upside down on top of the antenna chip 420 outside the area of the antenna structure 430. A combination of the antenna structure with active circuit blocks on one common chip shall be another embodiment.

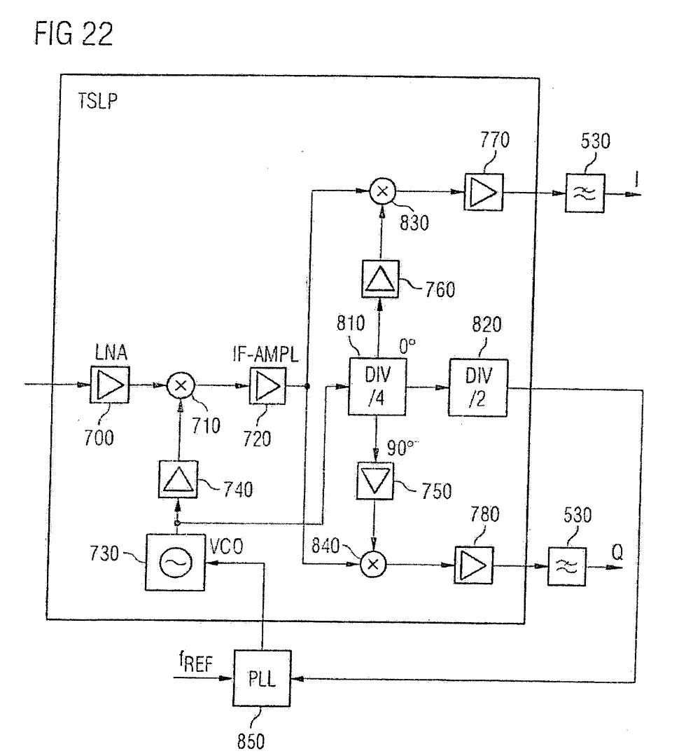

FIG. 22 is a circuit diagram an exemplary receiver part of a communication circuit that may be integrated on the RF circuit chip 520. This circuit should be regarded as a non-limiting example. It comprises a Low-Noise-Amplifier (LNA) 700, a first mixer 710, an intermediate frequency amplifier 720, a voltage controlled oscillator 730, amplifiers 740, 750, 760, 770, 780, a first frequency divider 810, a second frequency divider 820, and two second mixers 830, 840. The circuit is connected to an external phase locked loop 850.

The circuit 520 may be accompanied by an additional resonator chip 530 to filter the received signals, which can for example be a bulk acoustic wave filter or a DR filter etc.

In order to achieve a high level of integration of the electronic components on circuit 520, it is preferably, but not necessarily realized in SiGe-technology.

The examples discussed above are well applicable in radar applications. Due to the small wavelengths occurring in the target operation frequency range of about 76 to 81 GHz, very small antennas can be used. A typical antenna area is smaller than 2 mm².

The circuit 520 and the antenna chip 420 may be integrated on a single chip using a single substrate, which can contribute to further miniaturize the electronic apparatus and to reduce production costs. However, depending on technical requirements, chosen operating parameters and the like, it can be advantageous to employ separate chips for the antenna and the circuit as described above.

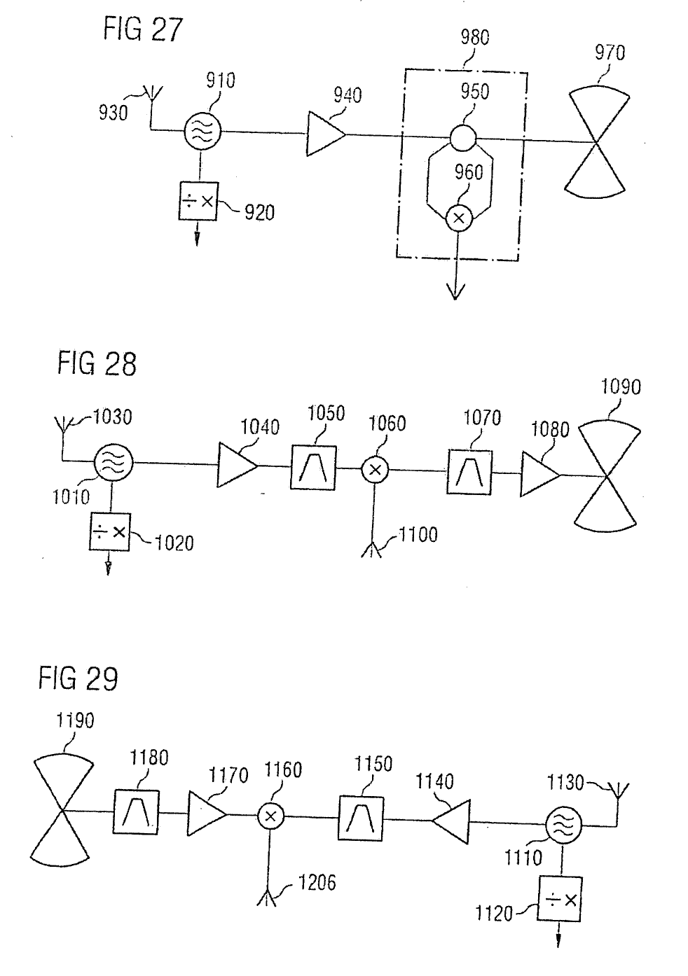

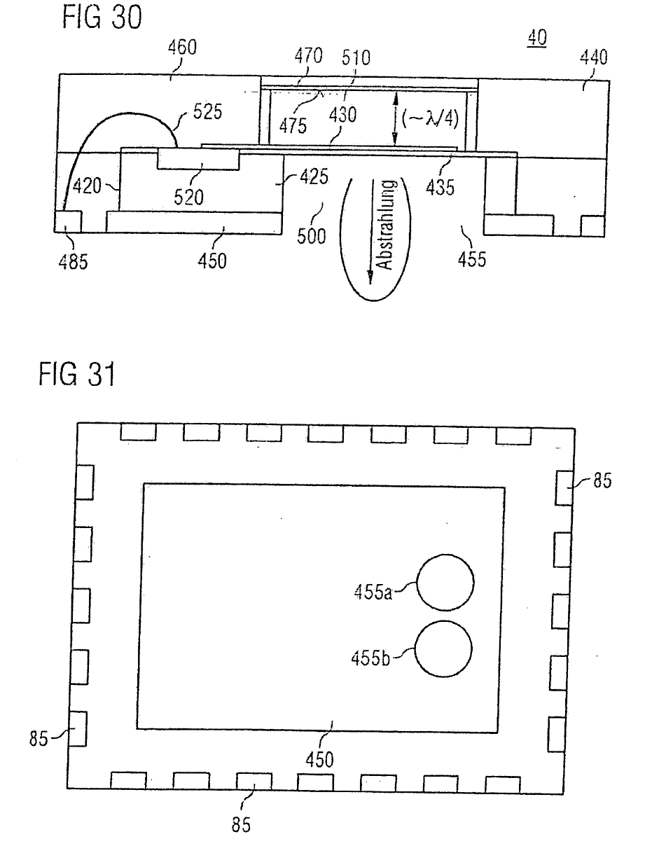

FIG. 27 shows a radar transmitting and receiving circuit integrated with antenna within one common Si substrate. The height and the caps (e.g. cap 470 in FIG. 23) of the voids above and/or below the antenna can be adjusted to allow for preferred radiation and/or reception to the top surface or bottom surface of the structure (FIGS. 30, 31). In case of radiation/reception to the bottom openings in the chip carrier can be provided.

The antenna structure 430 may be used to work as a radar antenna according to a variety of principles, which are continuous wave, continuous wave/doppler, Frequency Modulated Continuous Wave (FMCW), and pulsed mode. Of those, continuous wave and continuous wave/Doppler are most common. The FMCW mode is suitable to detect the distance to a target object, whereas pulsed mode may be preferred if energy consumption of the sensor should be minimized.

FIG. 24 illustrates an electronic apparatus 10 having an antenna chip 420 with a substrate 425 and an antenna structure 430. The antenna chip 420 is integrated or packaged in a package 440 having a chip mounting surface 450 for mounting the antenna chip, and an encapsulating material 460. The encapsulating material may be, but is not limited to a typical plastic mold compound used in the industrial packaging of integrated circuits. Suitable mold compounds are for example CEL 9240 HF, EME G770I, EME G760D-F, KMC 2520L.

As can be seen from FIG. 25 the encapsulating material may, as an alternative, also take the form of a lid 465, preferably a metal lid, having an opening 466 for radiating the signal power. As a further alternative the lid 465 does not comprise an opening 466 but, instead, chip mounting surface 450 comprises an opening adjacent to the void 500 in the antenna substrate 425 similar to the example of FIG. 30. Thereby, the distance between the antenna structure and the lid is preferably a quarter of the operating wavelength to support radiation in the direction of the back side of the antenna chip.

In case the encapsulating material is plastic mold compound (FIG. 24) a cap 470 is covering the antenna structure 430. A second void is disposed between the antenna structure 430 and the cap 470. The second void serves to improve the emission characteristics of the antenna, as without a void the mold material 460 would be in direct contact with the antenna structure, which might worsen the emission characteristics. This example can be combined with other features as hereinbefore described with respect to other examples.

Due to the small size of the antenna structure 430, it is possible to design the electronic apparatus with a very small volume of only a few mm³. A preferred package for small electronic systems is the Thin Small Leadless Package (TSLP). According to one example the apparatus comprises a TSLP package. A suitable TSLP package is available from Infineon Technologies, Munich, Germany. The height of the package is 0.4 mm, width 1.5 mm and length 2.3 mm.

The electronic apparatus may be used in other frequency ranges and is not limited to the range from about 76 to 81 GHz as described.

FIG. 26 shows another example using a Thin Small Leadless Package (TSLP). In order to connect the package 440 to a printed circuit board (not shown) the package 440 comprises land interconnects 485. The antenna chip 420 is directly connected to the contact lands 485 using wirebonds 525.

FIG. 27 shows a typical, simplified block diagram of a monostatic FMCW radar sensor. A VCO 910, which can be connected to an external PLL via a prescaler 920 and the tuning input 930, generates the frequency ramps. A buffer amplifier 940 amplifies the VCO output signal and isolates the VCO from the rest of the circuit. The amplified signal is fed to a directional coupler 950 that feeds a part of the signal to the antenna 970 where it is radiated and another part to the LO input of the mixer 960. The incoming signal is fed from the antenna 970 to the coupler 950, where a part is fed to the RF input of the mixer 960 where it is demodulated. In a simpler implementation, the transmit receive block 980 can also be a diode.

FIG. 28 shows a typical, simplified block diagram of a data transmitter. A VCO 1010, which can be connected to an external PLL via a prescaler 1020 and the tuning input 1030, generates the LO signal. A buffer amplifier 1040 amplifies the VCO output signal and isolates the VCO from the rest of the circuit. Via an optional filter 1050, the LO signal is fed to the LO input to an up-conversion mixer 1060, where the LO signal is modulated with a data signal 1100. After filtering with a filter 1070 and amplification 1080 the RF signal is fed to the antenna, where it is radiated.

FIG. 29 shows a typical, simplified block diagram of a data receiver. A VCO 1110, which can be connected to an external PLL via a prescaler 1120 and the tuning input 1130, generates the LO signal. A buffer amplifier 1140 amplifies the VCO output signal and isolates the VCO from the rest of the circuit. Via an optional filter 1150, the LO signal is fed to the LO input to a down-conversion mixer 1160, where the via antenna 1190, filter 1180 and LNA 1170 incoming signal is demodulated.

A combination of FIG. 28 and FIG. 29 on one common chip is also possible. This can be done with two individual antennas located at opposite sides of the chip or by one common antenna which is connected by a switch or a duplex filter to the transmit and receive block.

FIG. 30 shows an electronic apparatus 410 having an antenna chip 420 with a substrate 425 and an antenna structure 430. The antenna chip 420 is integrated or packaged in a package 440 having a conducting chip mounting surface 450 for mounting the antenna chip, and an encapsulating material 460. Below the antenna structure 430 a first void 500 is arranged in the substrate 425. In order to provide additional mechanical stability to the antenna structure 430, the antenna structure 430 is supported by a membrane 435 which separates the antenna structure 430 from the first void 500 in the substrate 425. Preferably, the membrane is made of non-conducting material, for example silicon oxide or silicon nitride. The membrane 435 may also comprises several layers of the same or different materials.

The electronic apparatus shown in FIG. 30 further comprises a second void 510 disposed between the antenna structure 430 and the encapsulating material 460. The second void 510 is provided by an additional cap 470 that is placed on the antenna structure 430 before the packaging of the apparatus, i.e. prior to the application of the mold mass 460. A suitable cap for this purpose is for example a SU8 frame that has been provided with conducting inner surface 475 to reflect the radiation emitted from the antenna structure 430. The height of the cap 470 may be adjusted to the individual operating wavelength. Preferably, height of the cap 470 is a quarter of the operating wavelength to support radiation in the direction of the back side of the antenna chip.

In order to allow the radiation to be emitted in the direction of the back side of the antenna chip the chip mounting surface 450 comprises openings 455 adjacent to the void 500 in the antenna substrate 425. FIG. 31 shows a corresponding sectional top view of the embodiment shown in FIG. 30. Thereby, antenna opening 455a in lead frame is used to transmit radiation from the antenna structure whereas antenna opening 455b in the lead frame is used to receive radiation.

A further example is illustrated in FIG. 30. Accordingly, the circuit 520 and the antenna chip 420 are integrated on a single chip using a single substrate, which can contribute to further miniaturize the electronic apparatus and to reduce production costs. Thereby, the circuit 520 is preferably a SiGe circuit.

The package shown in FIG. 30 is a Thin Small Leadless Package (TSLP). In order to connect the package 440 to a printed circuit board (not shown) the package 440 comprises land interconnects 485. The antenna chip 420 is directly connected to the contact lands 485 using wirebonds 525.

Although the invention has been shown and described with respect to a certain aspect or various aspects, it is obvious that equivalent alterations and modifications will occur to others skilled in the art upon the reading and understanding of this specification and the annexed drawings. In particular regard to the various functions performed by the above described components (assemblies, devices, circuits, units, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.” Also, exemplary is merely intended to mean an example, rather than the best.

1. An RF front-end, comprising:
an input configured to receive an oscillator signal;
an antenna port configured to transmit a transmission signal and receive a reception signal from an antenna;
a mixer comprising an RF-input configured to receive the reception signal, an oscillator input configured to receive a modified oscillator signal, and an output, wherein the mixer is configured to mix the received signal into an intermediate frequency band or a base band using the oscillator signal;
a directional coupler connected to the antenna port, the input for the oscillator signal, and the mixer, and configured to couple the oscillator signal as a transmission signal to the antenna via the antenna port, and couple the reception signal from the antenna to the RF-input of the mixer; and
a first phase shifter or a second phase shifter, where the first phase shifter is configured to regulate a phase of the transmission signal, and the second phase shifter is configured to regulate a phase of the oscillator signal to form the modified oscillator signal supplied to the oscillator input of the mixer.

2. The RF front-end of claim 1, wherein the second phase shifter is configured to alternately provide a phase shift of 0° and 90° to the oscillator signal that provided to the mixer, thus providing alternately inphase and quadrature components of a signal at the output of the mixer.

3. The RF front-end of claim 1, wherein the first phase shifter is configured to adjust the phase of the transmission signal for controlling the transmission characteristic of the antenna.

4. The RF front-end of claim 1, wherein the RF front-end is integrated in a single package.

5. The RF front-end of claim 4, wherein the RF front-end and the antenna are together arranged in a common package.

6. The RF front-end off claim 1, wherein the RF front-end comprises both the first and second phase shifters.

7. A receiver circuit, comprising:
an input configured to receive an oscillator signal;
an antenna port configured to receive a reception signal from an antenna;
a mixer comprising an RF-input configured to receive the reception signal, an oscillator input configured to receive a modified oscillator signal, and an output, wherein the mixer is configured to mix the reception signal into an intermediate frequency band or a base band using the modified oscillator signal;
a phase shifter configured to receive the oscillator signal and alternately provide a phase shift of 0° and 90° thereto and provide the alternating phase shifted oscillator signal to the oscillator input of the mixer as the modified oscillator signal, thus providing inphase and the quadrature components of a signal at the output of the mixer.

8. The receiver circuit of claim 7, wherein the receiver circuit is integrated in a package.

9. The receiver circuit of claim 8, wherein the receiver circuit and the antenna are integrated into a common package.
